(19) United States
(12) Patent Application Publication
(10) Pub. No.: US 2020/0089191 A1
(43) Pub. Date: Mar. 19, 2020

(54) METHOD FOR MONITORING CUTTING-TOOL ABRASION

(71) Applicant: Industrial Technology Research Institute, Hsinchu (TW)

(72) Inventors: Hsin-Chang Chang, Taichung (TW); Chia-Sheng Chiang, Taichung (TW); Yi-Chang Chen, Taichung (CN); Sheng-Yu Chuang, Nantou County (TW)

(21) Appl. No.: 16/214,378

(22) Filed: Dec. 10, 2018

(30) Foreign Application Priority Data
Sep. 18, 2018 (TW) 107132801

(51) Int. Cl. G05B 19/4065

(52) U.S. Cl. CPC G05B 19/4065; G05B 2219/36086

(57) ABSTRACT

A method for monitoring cutting-tool abrasion of a machine tool includes the steps of: defining a tolerance range of abrasion of a cutting tool; collecting loading data of the cutting tool at every continuous machining sections; extracting actual-cutting loading data from all the loading data; calculating coefficients of fitting lines of the loading data for individual machining sections according to the actual-cutting loading data; comparing the abrasion of the cutting tool according to the tolerance range and the fitted lines; and, if an outranged result occurs, issuing an alert message to adjust or to replace the cutting tool.

### CROSS REFERENCE TO RELATED APPLICATION

This application claims the benefits of Taiwan application Serial No. 107132801, filed on Sep. 18, 2018, the disclosures of which are incorporated by references herein in its entirety.

### TECHNICAL FIELD

The present disclosure relates in general to a method for monitoring cutting-tool abrasion, and more particularly to the method for monitoring cutting-tool abrasion/wear that utilizes one machining section as a basic period for collecting loading data, and introduces a predetermined regression equation and a standard deviation to express valid loading data of actual cutting within every axis so as to precisely determine upper and lower limits of loading, and also to resolve inconsistent ranges for matching time points in sampling loading.

### BACKGROUND

During a continuous process to perform repetitive machining upon same-type workpiece, if appropriate or in-time calibration upon cutting tools can be setup to check possible abrasion or wear, then manufacturing precision would be much better maintained. Generally speaking, a correction upon the cutting tool is usually carried out before unloading the finished workpiece, or after the finished workpiece is measured. In the case if the machining deviation is beyond a tolerance, necessary correction upon the corresponding cutting tool would be performed. Nevertheless, to meet various demands in machining precision, different timing to perform necessary measurements would be possible. For example, the timing might be up to an investigation of machining, at a time after a batch production, or each time of finishing the workpiece. Definitely, different measuring times would lead to different types of machining quality.

In the art, though many documents claiming accuracy of detecting cutting-tool abrasion/wear can be found, yet shortcomings thereof described below are practically inevitable.

In one teaching, a pilot cutting is performed upon sample workpieces to establish reference loading information by sampling the loading in fixed time intervals for each sample, then calculations are carried out to obtain corresponding means and variances in a time series, and finally corresponding upper and lower bounds for the pilot cutting can be determined according to the calculations. An obvious shortcoming is that, if practical or actual cutting is beyond the range defined by the upper and lower bounds (threshold values), more pilot runs should be performed to provide upper and lower reference data for the loading. It is understood that, to establish reliable time-series reference data, plenty pilot runs in cutting are needed. Thereupon, in an actual cutting process, manufacturing defects resulted from loading perturbations caused by cutting-tool abrasion or wear could be reduced.

In one teaching, tool crushing is detected by observing deviations upon the following variables: cutting time (for drilling), cutting time in a loading state, and maximal loading drop (between two consecutive samples in the time series). One shortcoming of this teaching is that, since all the aforesaid variables are absolute values in a normal cutting process till tool crushing, misjudgments could be made in determining a possibility of tool crushing, moderate abrasion/wear, and severe abrasion/wear.

In one teaching, multiple pilot runs in cutting are performed to obtain sampled data related to motor torques, a method for monitoring machining loads is set up according to the sampled data, and then, in a plurality of machining cycles, ranges to be monitored are modified with judgments of machinery efficiency according to variations of loading data. Yet, the shortcoming of this teaching is that, in order to monitor all loading data and to have an no-cut load as a modulating factor, sufficient data from preliminary machining cycles shall be captured as samples for a statistic purpose. Thus, it rises a limitation in matching the sampling timing and positions with respect to the machining cycle.

In one teaching, a plurality of machining cycles are utilized to investigate a plurality of predetermined load indices on the cutting tool. After obtaining averages of individual indices, corresponding thresholds are defined. By comparing the index for every machining, if the index doesn't exceed the threshold, then the index is added into a standard information so as to dynamically correct a monitoring range. If the index exceeds the threshold, then it implies that the cutting tool is in an abnormal state. One shortcoming of this teaching is that more information is required before abnormality of the cutting tool can be confirmed. Basically, the dynamic-corrected monitoring range is obtained by accumulating multiple historic machining data. If the abnormality of the cutting tool has existed for a while, then deviations in the index detection would be inevitable. In this teaching, with the extremal value and the absolute value as reference indices, the corresponding sensitivity in detection might be too high or too low. In addition, the application of judgments based on extremal values and absolute values is usually limited to simple machining such as drilling and screwing.

In one teaching, a reasonable loading database is established through a plurality of machining. By comparing loading after predetermined times of usage with the corresponding historic loading information, a determination whether or not each loading feature is within a reasonable range can be made. One shortcoming of this teaching is that the purpose of detection can be only achieved by collecting sufficient loading data. In addition, the reference information is mainly provided by the loading database, detection bias would be inevitable upon insufficient abnormal-state collected in the loading database.

In one teaching, by considering characteristics of cutting tool, workpiece, material, cutting depth and feed, a power demand and a corresponding threshold can be calculated for a specific machining environment. While in actual machining, if the threshold is exceeded, then a severe abrasion to the cutting tool is determined. One shortcoming of this teaching is that the calculation of the power demand for numerical control can be only determined through the knowledge of various characteristics of the machining.

In one teaching, an optical ruler is applied to measure abrasion or wear of cutting tools in actual machining, then a relationship between each abrasion and machinability realized by a specific sensor can be established, and the principal components analysis (PCA) is applied to capture the embedded features. While in actual machining, a least squares support vector machine (LS-SVM) is applied to predict the instant abrasion according to the given machinability. One shortcoming of this teaching is that, in order to meet various machining situations and characteristics, a huge amount of pre-cutting runs and a large number of force sensors are necessary for establishing a reliable reference information.

Accordingly, it is urgent in the art for developing an improved method for monitoring cutting-tool abrasion that can use static loading data to analyze dynamically a huge amount of continuous loading data, can keep both meaningful load-average curves and upper/lower limits of loading so as to mimic a reasonable loading range for the next machining, and can determine automatically a timing for correcting the abrasion so as to ensure machining quality for each individual workpiece.

### SUMMARY

In one embodiment of this disclosure, a method for monitoring cutting-tool abrasion applicable to a machine tool is provided. The machine tool uses machining commands for a plurality of machining sections to drive a cutting tool machining in an axial direction. The method for monitoring cutting-tool abrasion includes the steps of:

(a) defining a tolerance range of abrasion of a cutting tool;

(b) collecting loading data corresponding to each machining command of a machining section;

(c) according to the loading data, extracting correspondingly a plurality of actual-cutting loading data;

(d) according to the plurality of actual-cutting loading data, calculating correspondingly a plurality of fitted lines;

(e) according to the plurality of actual-cutting loading data and the plurality of fitted lines, determining whether or not the abrasion of the cutting tool is beyond the tolerance range; and

(f) if the abrasion of the cutting tool is not within the tolerance range, then issuing an alert message; or, if the abrasion of the cutting tool is within the tolerance range, then going back to step (b) and skipping step (d) if a criterion to end fitting is fulfilled.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a schematic view showing a framework to embody the method for monitoring cutting-tool abrasion in accordance with this disclosure;

FIG. 1B is a flowchart of the method of FIG. 1A;

FIG. 2 shows typically and schematically variations of loading upon a cutting tool experiencing continuous machining in accordance with this disclosure;

FIG. 3A is a schematic plot showing variations of loading within a single machining section with fitted lines corresponding to predetermined standard deviations;

FIG. 3B shows schematically a distribution of tolerance according to FIG. 3A;

FIG. 4 shows schematically variations of every axis actual-cutting loading upon the same cutting tool while in the first machining cycle;

FIG. 5A shows schematically variations of loading particularly at actual machining sections (enclosed individually by dashed squares);

FIG. 5B shows schematically a typical machining section with respect to corresponding actual operations;

FIG. 6A to FIG. 6D demonstrate orderly steps of a method for capturing an actual machining section in accordance with this disclosure;

FIG. 7 shows schematically curve-fitting results upon FIG. 4;

FIG. 8A shows schematically loading data of the second machining cycle in the first machining section in accordance with this disclosure;

FIG. 8B shows an amended FIG. 8A by further including fitted curves and standard deviations obtained by analyzing loading data of the first and second machining cycle in the first machining section; and

FIG. 8C shows a second machining cycle after the first machining cycle of FIG. 4 by further including fitted curves and standard deviations obtained by analyzing loading data of the first and second machining cycle.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

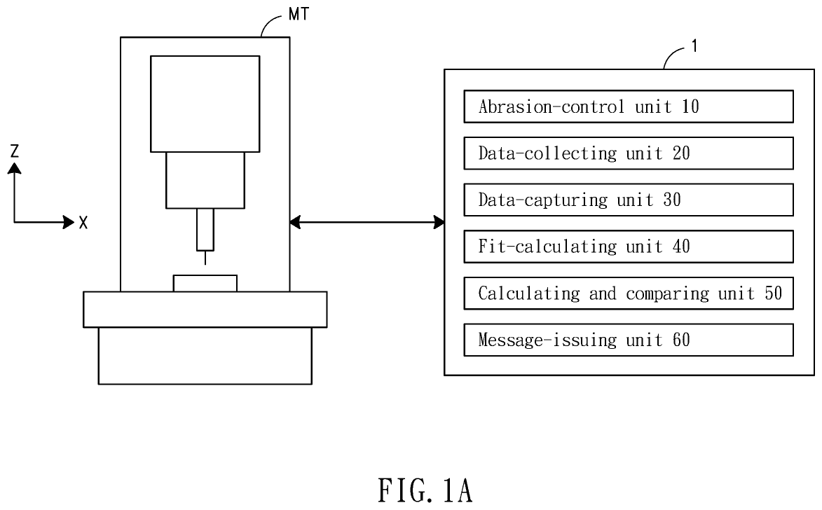

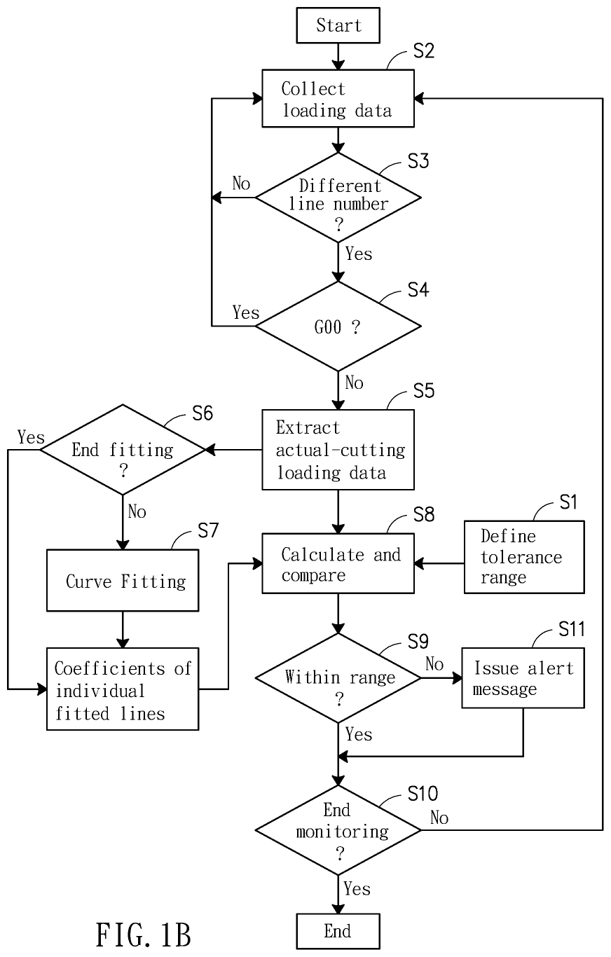

Referring now to FIG. 1A, the method for monitoring cutting-tool abrasion can be executed by a cutting-tool abrasion-monitoring system 1 consisted of an abrasion-control unit 10, a data-collecting unit 20, a data-capturing unit 30, a fit-calculating unit 40, a calculating and comparing unit 50 and a message-issuing unit 60. The cutting-tool abrasion-monitoring system 1 can be a computer or a controller which coupled with a machine tool MT. The machine tool MT is furnished with a cutting tool T moving axially in an X/Y/Z coordinate system so as to machine a workpiece loaded onto the machine tool MT. The machine tool MT communicates the system 1 with signals and instructions. It shall be noted that the aforesaid units for the system 1 can be arbitrarily combined or divided in accordance with this disclosure. In addition, it shall be explained that this disclosure is targeted to perform monitoring upon cutting-tool abrasion for a machine tool with computer numeric control (i.e., a CNC machine). In the following description, terms such as machining section, machining command, line number, NC code, G code, and G00˜G04 are all numerical-control (NC) program language or NC codes used in the computer numeric control. The “machining command” is a program code written in NC codes. Each line of the program code stands for an action command. Each action command is called as a “machining section”. Each line of the action command is assigned by a number standing for its position, and this number is the “line number”. To the skill in the art of computer numeric control, all above terms are well known terminologies, and thus details thereabout would be omitted herein. The method for monitoring cutting-tool abrasion in accordance with this disclosure is elucidated in detail as follows.

Referring now to FIG. 1B through FIG. 3B, the abrasion-control unit 10 is to define a tolerance range of abrasion for the cutting tool before a machining is initiated, according to expected machining types and precision demands (step S1).

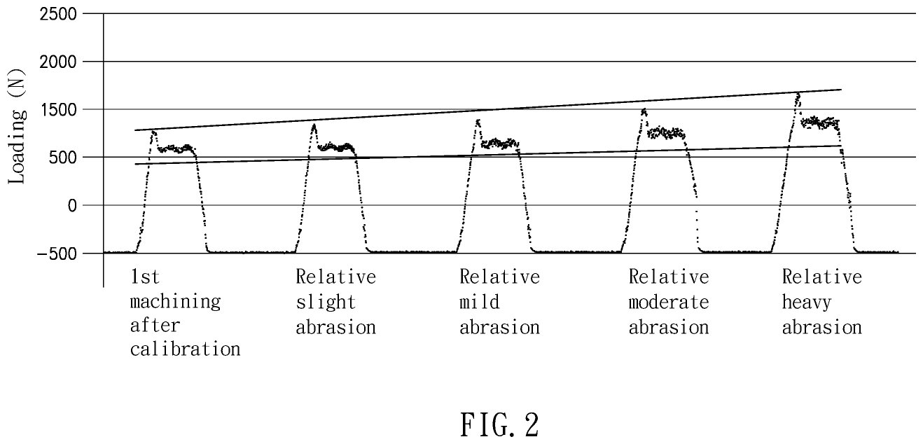

As shown in FIG. 2, while in performing “continuous and repetitive machining cycle upon identical workpieces”, as the machining goes back to the same machining section, the time-loading variations would exhibit similar patterns. After experiencing reciprocal machining, the cutting tool T would be gradually ground down to present a trend of loading typically shown in FIG. 2. Here, the so-called loading is the push acting on the cutting tool during the machining, and is obtained by transforming detections of force sensors. The loading data is consisted of all loading information varying in a time series.

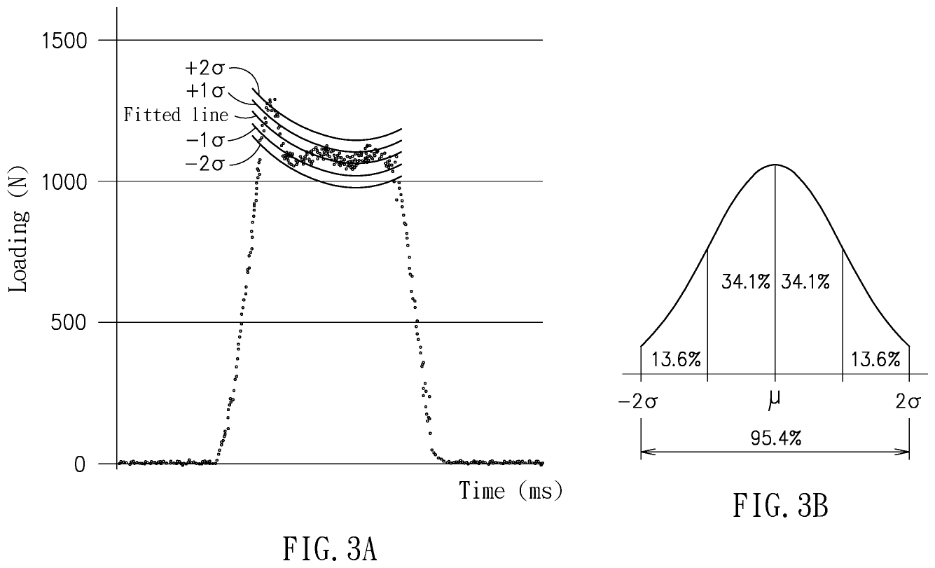

As shown in FIG. 3A and FIG. 3B, for example, while in machining a workpiece, a 5% out-of-range percentage is normally allowed (i.e., two standard deviations (G), or 95% coverage), and thus 2 standard deviations can be defined according to machining demands. If the out-of-range percentage reaches 10%, then a state of relative mild abrasion/wear is hit, and an alert message for meeting the “relative mild abrasion/wear” would be issued.

As shown in FIG. 1B, the data-collecting unit 20 is used for collecting loading data from the machine tool (step S2). According to different cutting tools and axial directions, continuous actual loading data are collected. In addition, the line number can be used to divide the loading data into sections. Namely, if the line number changes, then the loading data are divided accordingly.

The, step S3 is performed to judge if the line number is changed. If negative (the same line number), then go to step S2 for keeping collecting the loading data in the same machining section. If positive (different line number), then go to collect the loading data for the next machining section. In addition, the loading data already collected for the now-preceding machining section are transmitted to the data-capturing unit 30, and then step S4 is performed to determine whether the current stage is a state of actual machining (cutting in progress) or an idle state (no cutting at all). Namely, in step S4, the NC code is judged to be G00 or not (G00: linear rapid positioning without cutting).

In a machining process, by having the machining section as a basic for collecting data, then machining actions can be concisely separated into individual actions (G00/G01 linear feeding, G02/G03 arc feeding, G04 stop temporarily), such that the collection of the loading data can be simplified into a consequence of performing a specific machining action.

For example, in the case that a machining task involves three axes and three cutting tools, then axial loading data (axial loading percentage) for individual cutting tools are listed in Table 1 as follows.

TABLE 1

| Line | NC | | Tool | Tool | Tool | Tool | Tool | Tool | Tool | Tool | Tool |
|---|---|---|---|---|---|---|---|---|---|---|---|
| number | code | Run | 1 X | 1Y | 1Z | 2X | 2Y | 2Z | 3X | 3Y | 3Z |
| N0001 | G00 | 1 | 3.12 | 1.64 | 1.11 | 0.35 | 4.17 | 2.19 | 2.38 | 1.44 | 1.37 |
| | | 2 | 2.14 | 3.16 | 2.97 | 1.23 | 5.22 | 3.17 | 4.79 | 2.69 | 1.41 |
| | | 3 | 1.45 | 2.26 | 3.14 | 1.15 | 2.87 | 3.01 | 2.29 | 3.08 | 4.22 |
| | | 4 | 1.43 | 2.23 | 3.44 | 1.52 | 2.74 | 3.33 | 4.64 | 2.31 | 2.98 |
| N0002 | G02 | 5 | 84.31 | 45.72 | 2.33 | 2.56 | 3.21 | 2.11 | 4.23 | 5.56 | 3.15 |
| | | 6 | 79.31 | 43.52 | 3.41 | 2.33 | 3.12 | 3.21 | 2.19 | 3.37 | 2.01 |
| | | 7 | 78.64 | 50.68 | 2.57 | 2.15 | 4.28 | 3.88 | 2.58 | 0.99 | 2.00 |
| N0003 | G01 | 8 | 1.11 | 0.35 | 4.17 | 2.19 | 2.38 | 78.42 | 2.33 | 2.56 | 3.21 |
| | | 9 | 2.97 | 1.23 | 5.22 | 3.17 | 4.79 | 80.65 | 3.41 | 2.33 | 3.12 |
| | | . | . | . | . | . | . | . | . | . | . |
| | | . | . | . | . | . | . | . | . | . | . |
| | | . | . | . | . | . | . | . | . | . | . |

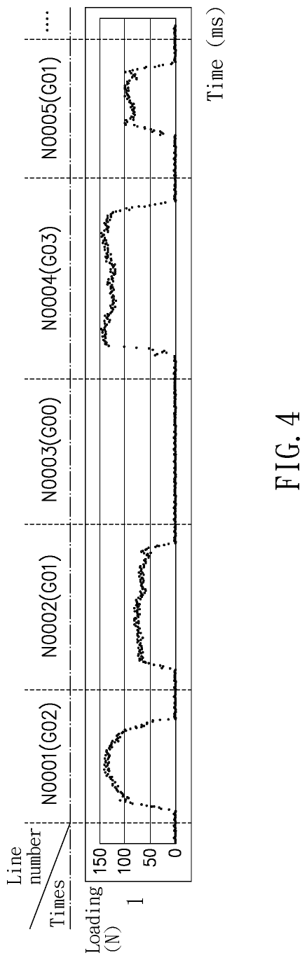

To make concisely the description, the example shown in FIG. 4 is presented. In FIG. 4, variations of every axis actual-cutting loading upon the same cutting tool while in a first machining cycle (including several machining sections) are schematically shown.

Referring now to FIG. 1A through FIG. 5A, the data-capturing unit 30 is to receive actual-cutting loading data for individual machining sections from the data-collecting unit 20. These incoming loading data would be classified in the data-capturing unit 30 to determine if or not the NC code of the machining section is G00 (i.e., step S4).

If a determination of step S4 is positive (i.e., the NC code of the machining section is G00), since G00 is a command for non-cutting move and move without contacting the workpiece, so the method disclosed herein goes directly back to the data-collecting unit 20 to continuously collect loading data for the next line number.

If the determination of step S4 is negative (i.e., the NC code of the machining section is a feed command like G01, G02 or G03), then it implies that the workpiece contact is inevitable upon performing machining related to the instant line number. Thus, the loading data being collected now are the actual-cutting loading data of the current machining section (step S5).

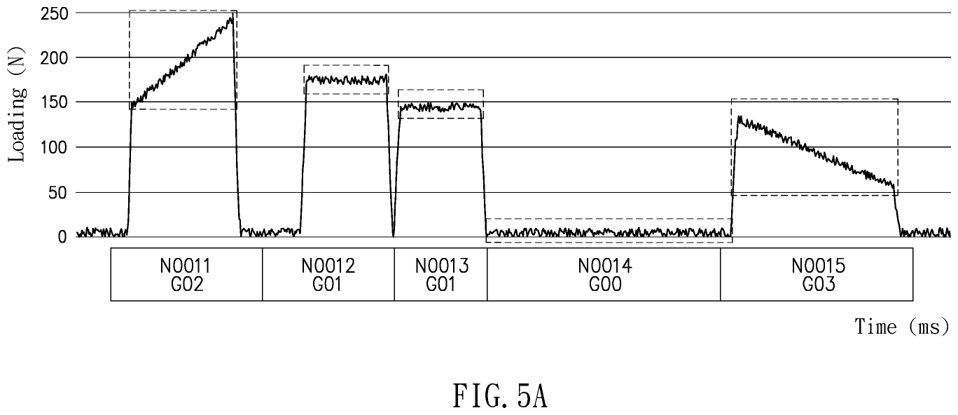

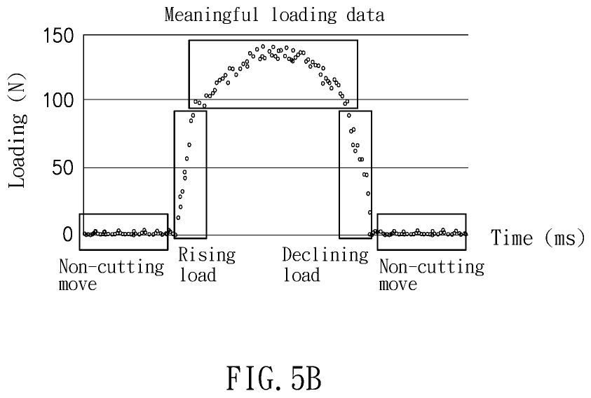

Referring now to FIG. 5B, since short non-cutting moves usually exist to both ends of the loading data collected for the same machining section, which are responsive to rising or declining loads. These idle-run data might bias the loading data for actual machining cycle, and thus shall be truncated in advance before a meaningful calculation can be made. Namely, the calculation is preferably based on the meaningful loading data in individual machining sections (enclosed by dashed squares in FIG. 5B). In addition, since no machining section can be really repeated, especially in timing, the introduction of a regression fitting algorithm and a concept of standard deviation in this disclosure can substantially minimize the aforesaid bias caused by non-cutting moves and repeatability. Thereupon, while in using time-series thresholds for comparison, the occurrence of miss-issuing an alert message caused by time-series shifts can be avoided.

In addition, the non-cutting move of G00 can be treated as a reference loading value for idle machining. By sampling the idle-machining loading data from the raw loading data, then meaningful variations of loading for actual machining cycle can be obtained.

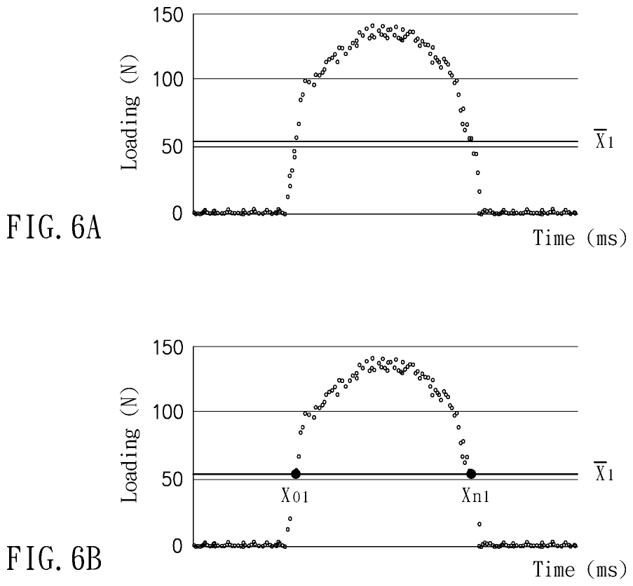

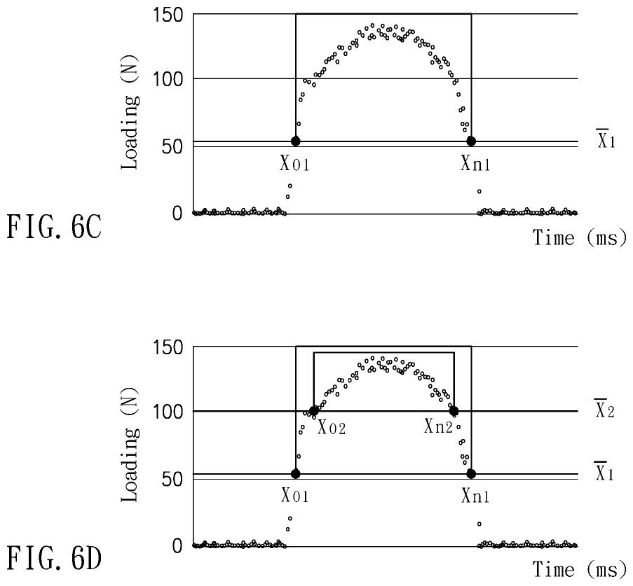

Referring now to FIG. 6A through FIG. 6D, a method for capturing an actual machining section in accordance with this disclosure includes the steps as follows.

Step i: calculate an average or mean value X̅₁ from the loading data of the entire machining section, as shown in FIG. 6A.

Step ii: locate point X₀₁ and point Xₙ₁, both of which have the loading equal substantially to the mean value X̅₁ obtained in the preceding step i, as shown in FIG. 6B.

Step iii: capture all the loading data between point X₀₁ and point Xₙ₁ to form a first-captured meaningful loading data, as shown in FIG. 6C.

Step iv: repeat aforesaid steps i-iii for about 2-5 times. Thereupon, a more reasonable machining section can be defined, as shown in FIG. 6D.

Referring now to FIG. 1A, the fit-calculating unit 40 is to process the actual-cutting loading data temporarily stored in individual machining sections. Preferably, by introducing a regression analysis and a statistic algorithm, coefficients for a linear regression equation and corresponding standard deviations for the every axis actual-cutting loading data in individual machining sections can be obtained. In this disclosure, the fitting line and the corresponding standard deviation are the reference for judging abnormality of machining.

After the captured time-series loading data are transmitted into the fit-calculating unit 40, the calculation of fitted lines for the first loading run can be performed (step S7). Namely, coefficients for the fitted lines from the first curve-fitting upon the actual-cutting loading data can be obtained, and these coefficients are then transmitted to the calculating and comparing unit 50.

Every time after the first curve fit is completed posterior to a calibration upon the cutting tool, coefficients for the fitted lines in individual machining sections of the same machining cycle can be obtained. Similarly, in the following second, third or more machining cycle, actual-cutting loading data are loaded to the corresponding machining sections so as to be accumulated into the loading data of the same machining section in the preceding machining cycle, so that new coefficients and corresponding standard deviations can be obtained. After a predetermined standard cumulative number for the machining cycle is reached, loading data of the same machining sections in the following machining cycle would be waived from the aforesaid calculation at the coefficients and the standard deviations. Namely, the final coefficients of the fitted lines and the corresponding standard deviations are generated after the predetermined standard cumulative number of machining cycle is reached (step S6). As long as the coefficients of the fitted lines and the corresponding standard deviations are obtained, the coefficients, the corresponding standard deviations and the actual-cutting loading data are transmitted to the calculating and comparing unit 50 for online calculations and comparisons upon the cutting-tool abrasion (step S8). Calculation and comparison are performed according to the standard deviations and the predetermined out-of-range percentages setup by the abrasion-control unit 10, and then determine if the abrasion of the cutting tool exceeds a corresponding limit (step S9). Namely, early since the first actual machining cycle, the calculation and the comparison has already begun. In particular, the first machining cycle is compared with the fitting results obtained from itself. In practical application, the simplest effective comparison is done with respect to the second machining cycle.

As described above, the fit-calculating unit 40 utilizes the regression analysis and the statistic algorithm to derive the coefficients of the linear regression equations and the corresponding standard deviations for every axis actual-cutting loading data in individual machining sections. The linear regression equation for specific machining section stands for the fitted lines obtained by evaluating the current machining section integrated with n preceding actual machining cycle, and the standard deviation stands for distributions of the fitted lines obtained by evaluating the current machining section integrated with n preceding actual machining cycle, in which n is a positive integer. According to a statistic model (by linear regression analysis) established by analyzing aforesaid actual-cutting loading data, and by defining the standard deviation as a limit, the abnormality of abrasion can be then determined by judging the out-of-range percentage.

Among various algorithms for calculating the linear regression equation, the least square criterion is implemented in this disclosure. In regression analysis, the aforesaid linear regressive algorithm can be substituted by an N-order curve-fitting regressive algorithm, where N is a positive integer. A typical equation is as follows.

Y=β₀+β₁X+β₂X²+β₃X³+ . . . +βₙXⁿ,n∈N

In which the higher the order is, the more similar fitted-curve can be obtained to match the original trend. However, the consumption to the calculation is the trade-off. In addition, the Y stands for the fitted-curve or line segment, and the β₀˜βₙ are coefficients of the equation. In this embodiment, a 2-order fitted curve is applied as follows.

Y=β₀+β₁X+β₂X²

According to the aforesaid embodiment, the actual-cutting loading data as shown in FIG. 4 for the first machining cycle are plugged into the calculation of linear regression with the least square criterion, then the equations for corresponding fitted curves of line numbers N0001, N0002, N0004 and N0005 (machining sections) are listed below.

Y₁=−121.54+5.0805X−0.025X²

Y₂=−164.9+1.688X−0.003X²

Y₄=1036.6−2.568X+0.0018X²

Y₅=−1915.9+4.4064X−0.0024X²

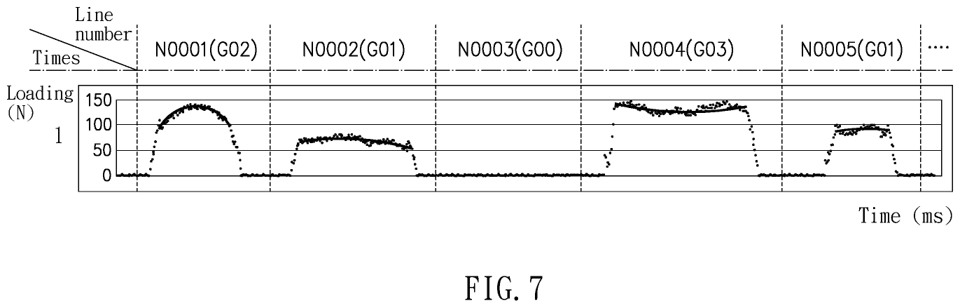

Referring now to FIG. 7, curve-fitting results upon the first machining cycle of FIG. 4 is schematically shown. The formula for calculating the standard deviation is:

$${σ}^{2} = \frac{{\sum }_{i = 1}^{n} {( {y}_{i} - E ( {y}_{i} ) )}^{2}}{n}$$

Then, it can be derived that:
N0001: σ₁²=11.28
N0002: σ₂²=26.77
N0004: σ₄²=−147.38
N0005: σ₅²=293.63

By preserving the aforesaid coefficients of the linear equations and the corresponding standard deviations, the fitted lines for the raw loading data of the first machining cycle. Curve-fitting results for the loading data of the first machining cycle are shown in Table 2 as follows.

TABLE 2

| | N0001 | N0002 | N0003 | N0004 | G0005 |
|---|---|---|---|---|---|
| | (G02) | (G01) | (G00) | (G03) | (G01) |
| β₀ | −121.54 | −164.9 | | 1036.6 | −1915.9 |
| β₁ | 5.0805 | 1.688 | | −2.568 | 4.4064 |
| β₂ | −0.025 | −0.003 | | 0.0018 | −0.0024 |
| σ² | 11.28 | 26.77 | | 147.38 | 293.63 |

In which β₀, β₁, β₂ are coefficients of the linear equation, with respect to line numbers N0001(G02), N0002(G01), N0004(G03), G0005(G01), respectively, and σ² is a square of the standard deviation. After the first fitting upon the loading data is finished, a first comparison to determine whether or not the abrasion of the cutting tool abrasion is within the tolerance range. Empirically, the first comparison would be positive. Then, go back to the data-collecting unit 20 for further collecting the loading data.

In order to make the fitted lines more robust, times for curve-fitting iterations shall be better defined. By feeding the loading data in the first few machining cycle out of a plurality of machining cycle to the iterative fitting calculation, the coefficients of the linear curve-fitting equations would be much more robust.

In this embodiment, the loading data of the first four machining cycle are captured for iterative fitting calculation. In the third machining cycle, since the preset fourth machining cycle haven't reached, thus after the calculating and comparing unit 50 confirms no preset out-of-range percentage is exceeded, then the actual-cutting loading data of the first and second machining cycle would be transmitted to the fit-calculating unit 40 again (from step S10 to step S7 via step S2) for re-calculating the curve fit with the loading data of the third machining cycle. Table 3 as follows lists results of the fourth iterative fitting calculation, in which all the loading data of the first, second, third and fourth machining cycle are integrated.

TABLE 3

| | N0001 | N0002 | N0003 | N0004 | G0005 |
|---|---|---|---|---|---|
| | (G02) | (G01) | (G00) | (G03) | (G01) |
| β₀ | −113.44 | −149.74 | | 1000.2 | −3192.2 |
| β₁ | 4.9125 | 1.584 | | −2.4765 | 7.1766 |
| β₂ | −0.0242 | −0.0028 | | 0.0018 | −0.0039 |
| σ² | 5.54 | 13.08 | | 140.54 | 263.59 |

in which β₀, β₁, β₂ are coefficients of the linear equation, with respect to the line numbers N0001(G02), N0002(G01), N0004(G03), G0005(G01), respectively, and σ² is a square of the standard deviation.

By comparing coefficients listed in Table 2 (including the loading data of the first machining cycle only) and Table 3 (including all the loading data of the first four machining cycle), it can be found that the standard deviations listed in Table 3 are better than those listed in Table 2, and thus robustness of information is better as well.

Referring back to FIG. 1A, the calculating and comparing unit 50 can base on the tolerance range of abrasion of the cutting tool defined by the user (step S1) to perform comparison of the cutting-tool abrasion (step S8). Calculation and comparison are performed according to the standard deviations and the predetermined out-of-range percentages setup by the abrasion-control unit 10, and then (in step S9) determine if the abrasion of the cutting tool exceeds the tolerance range.

If the abrasion of the cutting tool is determined to be within the tolerance range in step S9, then go further to step S10 to determine whether or not the monitoring should be ended. If positive, then stop the monitoring. If negative, then go back to step S2 for collecting continuously the loading data of the next machining cycle.

In step S11, if the comparison result determines that the abrasion of the cutting tool is abnormal (i.e., beyond the tolerance range), then the cutting tool is re-calibrated. After the cutting tool is calibrated, all the coefficients of the fitted lines will be completely erased. Namely, every time after the cutting tool is calibrated, collecting, capturing, fitting and comparing the loading data will be restarted. Thus, the cutting-tool state after the calibration is the reference cutting-tool state for the calculating and comparing unit 50 to compare the abrasion of the cutting tool.

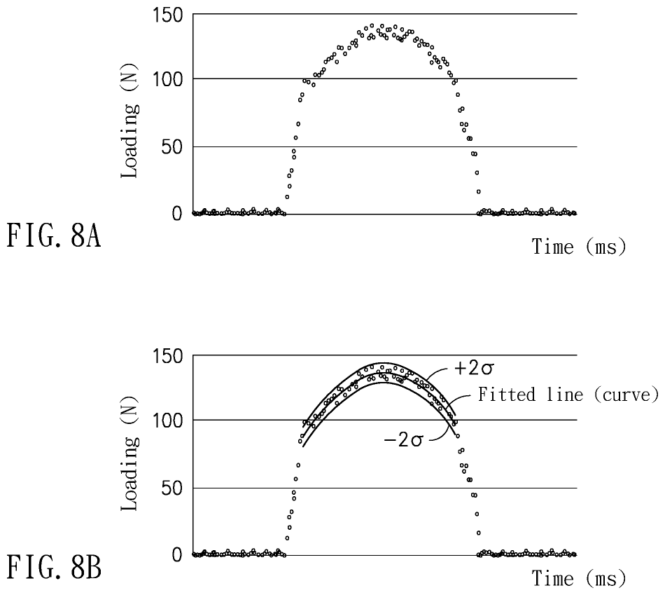

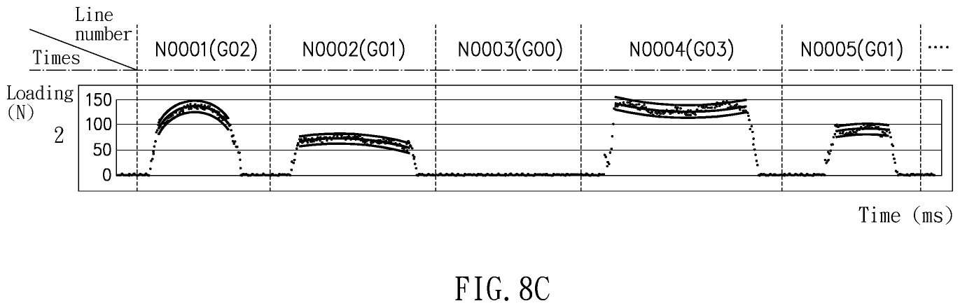

Referring now to FIG. 8A through FIG. 8C, to simplify the explanation, detection upon the every axis cutting-tool loading data is raised as an example. The detection method includes the steps as follows.

Step i: In the case that the out-of-range percentage is defined to be 10% for 2 standard deviations, and at this extreme state of the cutting tool is defined to have relative mild abrasion/wear. After the second machining starts, the loading data collected within the machining section N0001 are shown in FIG. 8A.

Step ii: Overlap (a) the fitted lines obtained by calculating the accumulated loading data of the same machining section N0001 in the first and second machining cycle and (b) the curves of 2 standard deviations onto the loading data of the machining section N0001 in the second machining cycle, as shown in FIG. 8B.

Step iii: After statistic calculation, the out-of-range percentage of the loading data at the machining section N0001 in the second machining cycle for 2 standard deviations is 3.57%.

As described above, the results of this embodiment are shown in FIG. 8C. After the abrasion of the cutting tool reaches a specific limit, beyond 10% out-of-range percentage defined at 2 standard deviations for example, then the message-issuing unit 60 would come in to handle the abnormality alert function. As shown in FIG. 8C, 10.32% out-of-range percentage is found at the line number N0001(G02), 11.47% out-of-range percentage is found at the line number N0002(G01), 12.51% out-of-range percentage is found at the line number N0004(G03), and 10.89% out-of-range percentage is found at the line number N0005(G01). All of them exceed 10% out-of-range percentage defined at 2 standard deviations, and thus the message-issuing unit 60 is introduced.

Referring now back to FIG. 1A, when the loading data in any axial direction and in any machining section exceed the predetermined out-of-range percentage at the preset standard deviation selected by the abrasion-control unit 10, the message-issuing unit 60 would then get involved to alert related personnel to calibrate or to replace the cutting tool in time.

In summary, the method for monitoring cutting-tool abrasion provided by this disclosure is applied to a situation of “continuous and repetitive machining cycle upon identical workpieces”. Whenever the same machining section is executed, the corresponding time-loading variations would present similar trends. The loading data of individual machining section are used to calculate linear regressive results and corresponding standard deviations. In particular, the linear regression equation defines the fitted lines, and the standard deviations of the fitted lines corresponding to the actual-cutting loading data are to define the upper/lower limits for distributing the loading data. After a plurality of machining cycle, the cutting tool will be gradually ground out, and thus the fitted lines and corresponding variations between the machining cycles would be substantially lifted up or expanded. Thus, according to the predetermined reasonable loading range and the allowable out-of-range percentage, the issuing of an alert message for correcting the abrasion of the cutting tool can be determined. This alert message can be also used for alerting related personnel to amend the cutting-tool abrasion or to replace the cutting tool in time. Thereupon, the machining quality can be maintained at a specific level.

In this disclosure, the method for monitoring cutting-tool abrasion uses the machining section as a basic unit for information collection. Then, variations of valid machining load within individual machining section can be expressed by a combination of the linear equation and the standard deviations, such that definition for the upper and lower limits of loading can be more precise. Thus, the aforesaid problem in inconsistent sampling timing and ranges can be substantially resolved. By introducing the method for monitoring cutting-tool abrasion in this disclosure, following advantages can be obtained.
Avoid tool crushing, and prevent the cutting-tool abrasion from reducing the machining quality
Achieve monitoring goal by high-efficiency technique
with the least number of pilot machining
with the least number of sensors, need only sensors to detect loading (current or torque)
Provide a reliable and robust detecting method
preventing sensor noise ripples from causing fault alert messages
preventing overshoot in chip loading from causing fault alert messages
preventing ill setup in critical values from causing fault alert messages and fault rejection
Achieve machining precision by adjusting parameters to better monitor the abrasion of the cutting tool
relative mild abrasion/wear, i.e., high precision
relative moderate abrasion/wear, i.e., loose precision
relative heavy abrasion/wear, i.e., avoiding tool crushing

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for monitoring cutting-tool abrasion, applicable to a machine tool, the machine tool using machining commands for a plurality of machining sections to drive a cutting tool to machine in an axial direction, comprising the steps of:
(a) defining a tolerance range of abrasion of the cutting tool;
(b) collecting loading data corresponding to each of the machining commands for the plurality of machining sections;
(c) according to the loading data, extracting a plurality of actual-cutting loading data;
(d) according to the plurality of actual-cutting loading data, calculating correspondingly a plurality of fitted lines, the plurality of fitted lines including a plurality of coefficients of the plurality of fitted lines;
(e) according to the plurality of actual-cutting loading data and the plurality of fitted lines, determining whether or not the abrasion of the cutting tool is within the tolerance range; and
(f) if the abrasion of the cutting tool is not within the tolerance range, then issuing an alert message; and, if the abrasion of the cutting tool is within the tolerance range, then going back to step (b).

2. The method for monitoring cutting-tool abrasion of claim 1, wherein the loading data are loading variations of the cutting tool in a time series.

3. The method for monitoring cutting-tool abrasion of claim 1, wherein, in the step (b), the loading data are divided by line numbers of the machining commands for the plurality of machining sections.

4. The method for monitoring cutting-tool abrasion of claim 1, wherein, in the step (c), “extracting a plurality of actual-cutting loading data” is determined by judging whether or not an actual machining cycle is performed according to the machining commands for the plurality of machining sections.

5. The method for monitoring cutting-tool abrasion of claim 1, wherein, in the step (d), “calculating correspondingly a plurality of fitted lines” is performed according to a linear regression equation.

6. The method for monitoring cutting-tool abrasion of claim 1, wherein the tolerance range is determined by the plurality of fitted lines and a standard deviation formula.

7. The method for monitoring cutting-tool abrasion of claim 1, wherein, in the step (f), after going back to the step (b) as the abrasion of the cutting tool within the tolerance range is determined, the step (d) is skipped if a predetermined standard cumulative number is met.

8. The method for monitoring cutting-tool abrasion of claim 1, wherein the plurality of actual-cutting loading data are determined by iteratively capturing the loading data between two points of the loading data, each of the two points having a loading value equal to a mean value of the loading data.
